(19) United States
(12) Patent Application Publication
(10) Pub. No.: US 2018/0174193 A1
(43) Pub. Date: Jun. 21, 2018

(54) METHOD AND SYSTEM FOR SELECTIVELY PROVIDING ELECTRONIC CONTENT TO MOBILE DEVICES

(71) Applicant: MasterCard International Incorporated, Purchase, NY (US)

(72) Inventor: Ankur Arora, New Delhi (IN)

(21) Appl. No.: 15/810,326

(22) Filed: Nov. 13, 2017

(30) Foreign Application Priority Data
Dec. 21, 2016 (SG) 10201610726U

(51) Int. Cl. G06Q 30/02; G06F 17/30

(52) U.S. Cl. CPC G06Q 30/0267; G06F 17/30864; G06Q 30/0277

(57) ABSTRACT

The present disclosure generally relates to a computerized method implemented on a system for selectively providing electronic content to mobile devices. The method comprises: collecting, by a host server and from a computing system at a merchant location, device identifier data of the mobile devices proximate to the merchant location; retrieving, from a customer database of the host server, details of payment vehicles linked to the mobile devices based on the device identifier data; searching a transaction database of the host server for past transactions associated with the payment vehicles based on the details thereof; selecting a set of payment vehicles based on the search results, each selected payment vehicle having performed at least one past transaction at the merchant location; identifying, for each selected payment vehicle, an issuer financial institution associated with the selected payment vehicle based on the details thereof; communicating details of the selected set of payment vehicles from the host server to the respective issuer financial institutions; and communicating the electronic content from the identified issuer financial institutions to the respective mobile devices linked to the selected payment vehicles. The electronic content is selected based on the past transactions performed by the selected set of payment vehicles at the merchant location.

### CROSS-REFERENCE TO RELATED APPLICATION

This application is a U.S. National Stage filing under 35 U.S.C. § 119, based on and claiming benefits of and priority to Singapore Patent Application No. 10201610726U filed on Dec. 21, 2016. The entire disclosure of the above application is incorporated herein by reference.

### TECHNICAL FIELD

The present disclosure generally relates to a method and system for selectively providing electronic content to mobile devices. More particularly, the present disclosure describes various embodiments of a method and system for providing electronic content to the mobile devices of customers based on proximity to a merchant location and past transactions at the merchant location.

### BACKGROUND

Advertising may be defined as a form of marketing communication for promoting or selling a product and/or service. Vendors such as financial institutions, e.g. banks and credit card issuers, merchants, businesses, commercial entities, retailers, etc. often rely on advertising channels to attract customers to purchase their goods/products/services. Promotions, discounts, vouchers, rebates, etc. may be offered in advertisements or advertisement/advertising/promotion/marketing materials communicated to customers. Advertisements may be computerized or digitized, i.e. advertisements that can be electronically communicated in the form of electronic content to electronic or digital devices of the customers.

Some vendors try to retain their customers by offering them special or exclusive discounts, such as when they launch new products. Some merchants and retailers try to incentive their customers to spend more at their shops, such as by offering discounts on bulk purchases. However, advertisements on such offers are sometimes only sent to the customers arbitrarily or during certain situations such as when the merchant has excess stock or is launching a new product. When customers receive such advertisements, they may not be able to respond or visit the shops within the offer period stated in the advertisements, such as because they are not near the shops or have no intention of shopping there. Or when the customers do pass by the shops, they may have forgotten ever seeing such an advertisement. As such, expenses spent by merchants on such advertisements tend to be wasted due to the low response rate.

U.S. patent publication 2016/0217446 discloses a system for selecting advertisements for a user, particularly based on proximity of the user to a merchant. The location data of the user is derived from global positioning system (GPS). However, there are inherent limitations of using GPS, particularly on the accuracy of the user's actual location. Further, if the user is in a building with merchants/retailers and commercial offices, GPS may indicate the user as being in the building only. The user may be working in the offices instead of shopping at the merchants/retailers.

Therefore, in order to address or alleviate at least one of the aforementioned problems and/or disadvantages, there is a need to provide a method and system for selectively providing electronic content to mobile devices, in which there is at least one improved feature over the aforementioned prior art.

### SUMMARY

According to a first aspect of the present disclosure, there is a system and computerized method thereon for selectively providing electronic content to mobile devices. The method comprises: collecting, by a host server and from a computing system at a merchant location, device identifier data of the mobile devices proximate to the merchant location; retrieving, from a customer database of the host server, details of payment vehicles linked to the mobile devices based on the device identifier data; searching a transaction database of the host server for past transactions associated with the payment vehicles based on the details thereof; selecting a set of payment vehicles based on the search results, each selected payment vehicle having performed at least one past transaction at the merchant location; identifying, for each selected payment vehicle, an issuer financial institution associated with the selected payment vehicle based on the details thereof; communicating details of the selected set of payment vehicles from the host server to the respective issuer financial institutions; and communicating the electronic content from the identified issuer financial institutions to the respective mobile devices linked to the selected payment vehicles. The electronic content is selected based on the past transactions performed by the selected set of payment vehicles at the merchant location.

According to a second aspect of the present disclosure, there is computerized method implemented on a host server for selectively providing electronic content to mobile devices, a host server implementing the method, and a non-transitory computer-readable medium storing computer-readable instructions that, when executed, cause a processor to perform steps of the method. The method comprises: collecting, by a data collection module of the host server and from a computing system at a merchant location, device identifier data of the mobile devices proximate to the merchant location; retrieving, by a data retrieval module of the host server and from a customer database of the host server, details of payment vehicles linked to the mobile devices based on the device identifier data; searching a transaction database of the host server, by a search module of the host server, for past transactions associated with the payment vehicles based on the details thereof; and selecting, by a selection module of the host server, a set of payment vehicles based on the search results, each selected payment vehicle having performed at least one past transaction at the merchant location. The electronic content is subsequently receivable on the mobile devices linked to the selected set of payment vehicles; and the electronic content is selected based on the past transactions performed by the selected set of payment vehicles at the merchant location.

An advantage of one or more of the above aspects of the present disclosure is that the electronic content, e.g. electronic/digital advertisements are more targeted to the customers based on the proximity to and past transactions at the merchant location. There would also be increased expectation that the customers may make purchases upon seeing the electronic content. This would eventually lead to increased sales for the merchants and also increased revenue for the issuer financial institutions due to the increased spending.

A method and system for selectively providing electronic content to mobile devices according to the present disclosure is thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 is an illustration of a system for implementation of a method for grouping of customers to subsequently receive advertisements, in accordance with an embodiment of the present disclosure.

FIG. 2 is a block diagram illustration of the technical architecture of a computing system, in accordance with an embodiment of the present disclosure.

FIG. 3 is a flowchart illustration of a method implemented on a computing system for grouping of customers to subsequently receive advertisements, in accordance with an embodiment of the present disclosure.

FIG. 4 is a flowchart illustration of a method implemented on a computing system for grouping of customers to subsequently receive advertisements, in accordance with another embodiment of the present disclosure.

### DETAILED DESCRIPTION

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “/” in a figure or associated text is understood to mean “and/or” unless otherwise indicated. As used herein, the terms “set” is defined as a non-empty finite organization of elements that mathematically exhibits a cardinality of at least one (e.g. a set as defined herein can correspond to a unit, singlet, or single element set, or a multiple element set), in accordance with known mathematical definitions.

For purposes of brevity and clarity, descriptions of embodiments of the present disclosure are directed to a method and system for selectively providing electronic content to mobile devices of customers, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

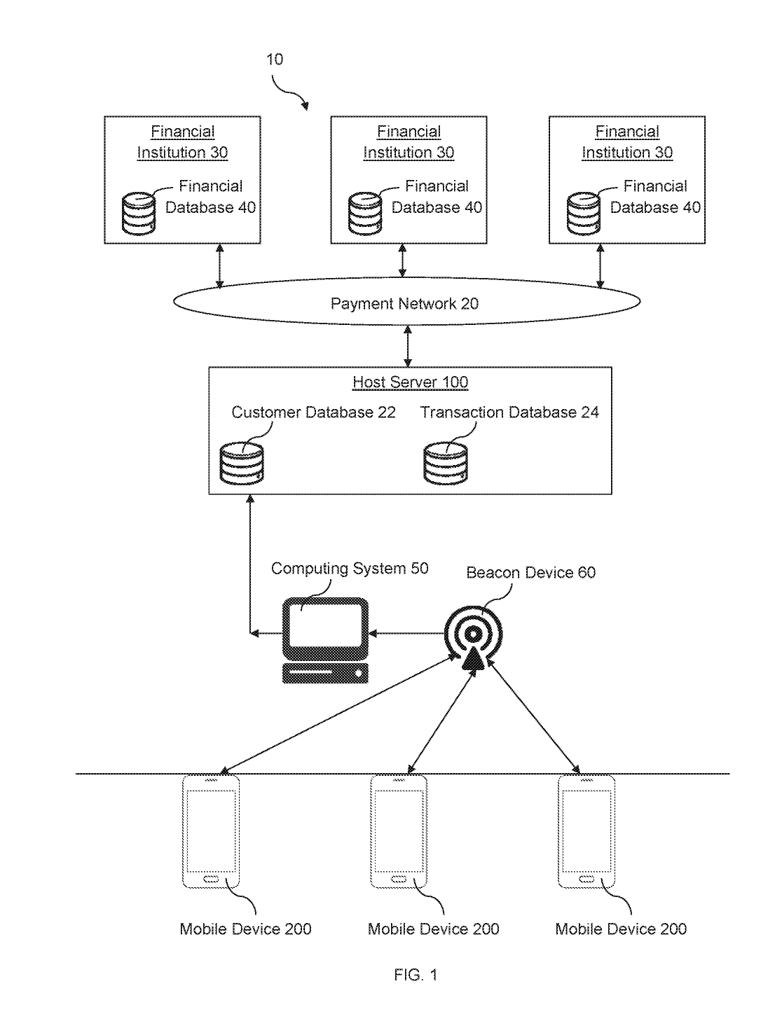

In representative or exemplary embodiments of the present disclosure, there is provided a system 10 as illustrated in FIG. 1. The system 10 comprises a host server 100 having a processor and a data storage device or memory configured to store computer-readable instructions. The host server 100 is operative for selectively providing electronic content such as electronic advertisements to mobile devices 200. Particularly, the host server 100 is operative for producing electronic content to mobile devices 200 belonging to customers based on proximity to and past transactions at a merchant location. The merchant location may refer to a shopping mall or a commercial building, wherein there are multiple vendors, merchants, retailers, shops, etc. that provide or sell merchandise to customers. The mobile devices 200 of customers, e.g. carried by the customers when they go to the merchant location, may be mobile phones, smartphones, personal digital assistants (PDAs), tablets, and/or laptops.

A mobile device 200 of the customer may be linked to a customer payment vehicle or instrument, such as payment cards. The term “payment card” may refer to a credit card, debit card, prepaid card, or charge card which the customer may use to pay for transactions. Details of such cashless payment vehicles/instruments may be stored electronically on the mobile device 200. A payment vehicle such as a payment card or credit card may be issued by an issuer financial institution or bank 30. A customer may possess one or more payment vehicles issued by one or more issuer financial institutions 30. The customer may also have one or more mobile devices 200, each of which may be configured with or linked to one or more payment vehicles.

The mobile device 200 may thus be referred to as a digital wallet that allows the customer to make electronic commerce transactions with merchants. Such transactions may be paid for with the linked payment vehicle, such as for online purchases or through merchant billing machines/point-of-sale (POS) terminals that are configured to accept digital wallets. The digital wallet may be operated on a software application executable on the mobile device 200. The software application may allow the customer to create a user profile with his/her preferred payment vehicles. The user profile may include an option for the customer to select whether he/she wishes to receive electronic advertisements.

The system 10 further comprises a payment network 20 that may be operated by an organization such as a payment card or credit card association. The host server 100 is communicatively linked to the payment network 20, or it may alternatively be interpreted that the host server 100 is communicatively linked such that it forms part of or is integrally connected within the payment network 20. The host server 100 comprises a customer database 22 and a transaction database 24 for recording and maintaining details of customers and their transactions. Particularly, the customer database 22 contains information on the payment vehicles of the customers, e.g. identity of the customer associated with a payment vehicle, and the transaction database 24 contains data on transactions between customers and merchants paid with the payment vehicles. The customer database 22 and transaction database 24 may reside locally on the host server 100, or alternatively on a remote server or computer communicatively linked to the host server 100. It would be appreciated that the customer database 22 and transaction database 24 may be distinct from each other, or integrated together as a single database.

The payment network 20 additionally connects or links together multiple financial institutions (e.g. banks and credit card institutions), particularly issuer financial institutions 30 that issue payment cards (e.g. credit cards) to customers. The host server 100 is thus communicable with each issuer financial institution 30 via the payment network 200. It would be appreciated that a person may be a customer of a financial institution 30 (as a user of their issued payment cards) and a merchant (as a purchaser of their products/services).

Each financial institution 30 may have one or more customers, i.e. a population of customers, and each customer may be a customer of one or more financial institutions 30. Each financial institution 30 may comprise a financial database 40 for recording information of every customer of the financial institution 30. The information in the financial database 40 may include device identifier data, profile, demographic information, and/or financial information of the customers. The financial database 40 may reside on a local server or computer of the financial institution 30, or alternatively on a remote server or computer communicatively linked to the issuer financial institution 30.

The system 10 further comprises components located at or near the merchant location, including a computing system 50. In some embodiments, the merchant location where multiple merchants are operating may comprise a single computing system 50. In some other embodiments, each merchant may have a computing system 50. The computing system 50 may comprise or may be communicatively linked to one or more beacon devices 60 for detection by nearby portable electronics devices, such as the mobile devices 200 of the customers. The beacon device 60 continuously broadcasts an identifier data signal or data packet that enables a mobile device 200 to ping and detect the presence of the beacon device 60 when the mobile device 200 is near the beacon device 60. The beacon device 60 may be configured for one or more communications protocol, such as Wi-Fi and Bluetooth low energy (BLE).

One or more vendors, merchants, and/or retailers may be operating at the merchant location. Each merchant may have a retail shop and a merchant electronic device for performing cashless payment transactions with customers. Each merchant electronic device is communicable with the host server 100 which functions as a payment gateway to the payment network 20 where the payment transactions are processed. The merchant electronic device 200 may be a computing device, such as a merchant billing machine/POS terminal. When the customer goes to the merchant and intends to purchase a product, the customer may present his/her mobile device 200 (which functions as a digital wallet) to the merchant to pay for the transaction via the merchant electronic device.

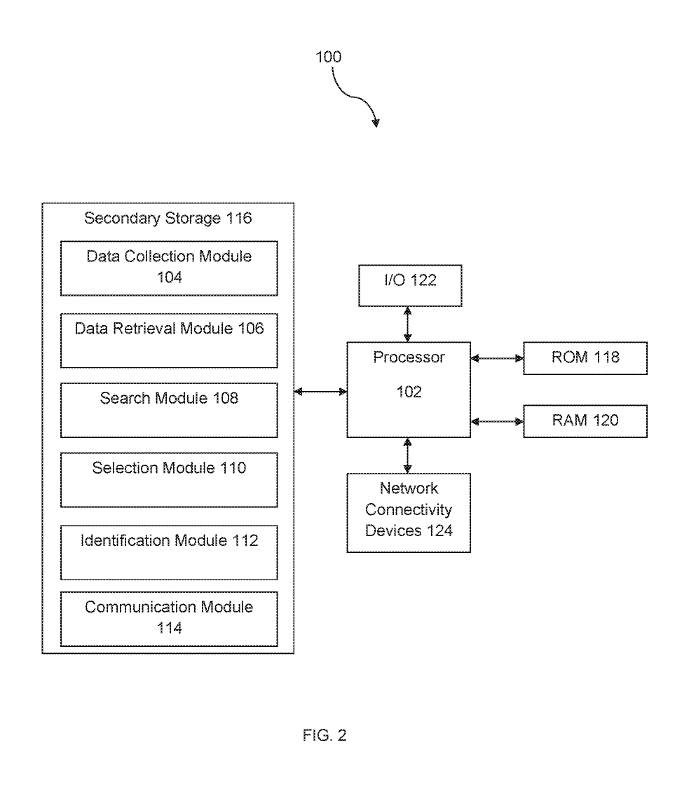

With further reference to FIG. 2, the host server 100 comprises a processor 102 for executing computer-readable instructions and a data storage device. The data storage device comprises a data collection module/component 104, a data retrieval module/component 106, a search module/component 108, a selection module/component 110, an identification module/component 112, a communication module/component 114, and a memory or a set of memory devices configured to store computer-readable instructions. The host server 100 controls and manages operations of the financial institution 30, and is communicatively linked to the customer database 32 and financial database 34 for transmitting and receiving data therewith. The customer database 32 and financial database 34 may reside on the host server 100, or alternatively on a remote computer communicatively linked to the host server 100.

The following is a description of the technical architecture of the host server 100 with reference to FIG. 2.

FIG. 2 illustrates a block diagram showing a technical architecture of the host server 100. The technical architecture includes a processor 102 (which may be referred to as a central processor unit or CPU) that is in communication with memory devices including the data storage device or secondary storage 116 (such as disk drives or memory cards), read only memory (ROM) 118, and random access memory (RAM) 120. The processor 102 may be implemented as one or more CPU chips. The technical architecture further comprises input/output (I/O) devices 122, and network connectivity devices 124.

The secondary storage 116 is typically comprised of one or more memory cards, disk drives, tape drives, or other storage devices and is used for non-volatile storage of data and as an over-flow data storage device if RAM 120 is not large enough to hold all working data. The secondary storage 116 may be used to store programs which are loaded into RAM 120 when such programs are selected for execution.

The secondary storage 116 has processing modules or components comprising non-transitory instructions operative by the processor 102 to perform various operations and steps according to various embodiments of the present disclosure. The processing components of the secondary storage 116 may include a data collection module/component 104, a data retrieval module/component 106, a search module/component 108, a selection module/component 110, an identification module/component 112, a communication module/component 114, and a memory or a set of memory devices comprising non-transitory instructions operative by the processor 102 to perform the various operations and steps. Non-transitory computer-readable media include all computer-readable media, with the sole exception being a transitory propagating signal per se.

As depicted in FIG. 2, the modules 104, 106, 108, 110, 112, and 114 are distinct modules which perform respective functions implemented by the host server 100. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the modules 104, 106, 108, 110, 112, and 114 is described herein, these may alternatively be implemented as one or more hardware modules (such as field-programmable gate array(s) or application-specific integrated circuit(s)) comprising circuitry which implements equivalent functionality to that implemented in software. The ROM 118 is used to store instructions and perhaps data which are read during program execution. The secondary storage 116, the ROM 118, and/or the RAM 120 may be referred to in some contexts as computer-readable storage media and/or non-transitory computer-readable media.

The I/O devices 122 may include printers, video monitors, liquid crystal displays (LCDs), plasma displays, touch screen displays, keyboards, keypads, switches, dials, mice, track balls, voice recognizers, card readers, paper tape readers, and/or other well-known input devices.

The network connectivity devices 124 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 124 may enable the processor 102 to communicate with the Internet or one or more intranets. With such a network connection, it is contemplated that the processor 102 might receive information from the network, or might output information to the network in the course of performing various operations or steps according to various embodiments of the present disclosure. Such information, which is often represented as a sequence of instructions to be executed using processor 102, may be received from and outputted to the network, for example, in the form of a computer data signal embodied in a carrier wave.

The processor 102 executes instructions, codes, computer programs, scripts which it accesses from hard disk, floppy disk, optical disk (these various disk based systems may all be considered as or part of the secondary storage 116), flash drive, ROM 118, RAM 120, or the network connectivity devices 124. While only one processor 102 is shown, multiple processors may be present. Thus, while instructions may be discussed as executed by a processor, the instructions may be executed simultaneously, serially, or otherwise executed by one or multiple processors.

It should be appreciated that the technical architecture of the host server 100 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture of the host server 100, at least one of the CPU 102, the ROM 118, and the RAM 120 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by well-known design rules.

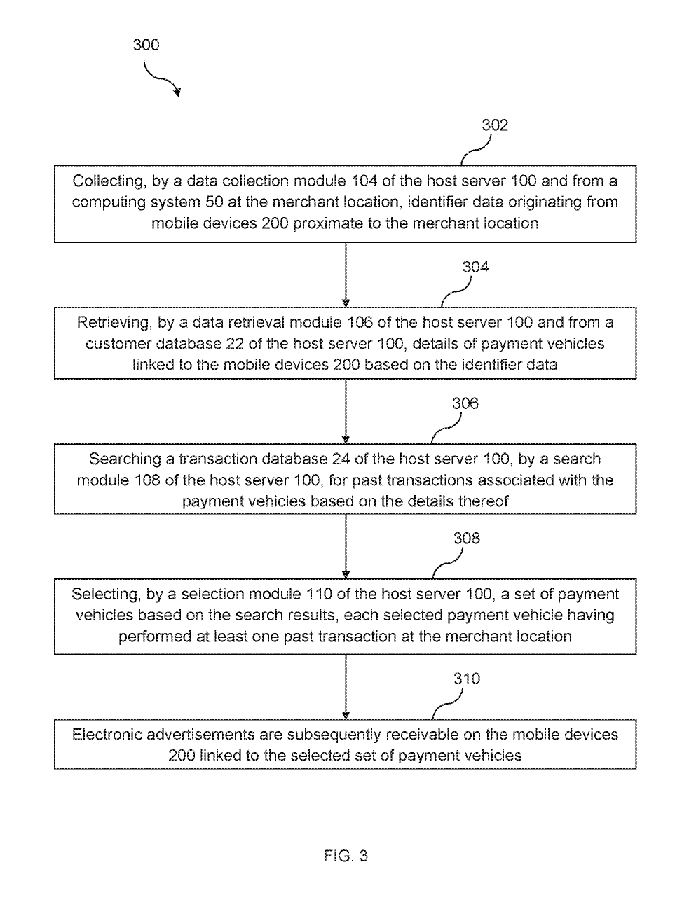

In various embodiments with reference to FIG. 3, there is a computer-implemented or computerized method 300, i.e. implemented on the host server 100, for selectively providing electronic content to mobile devices 200.

The method 300 broadly comprises:
a. a step 302 of collecting, by a data collection module 104 of the host server 100 and from a computing system 50 at the merchant location, device identifier data of mobile devices 200 proximate to the merchant location;
b. a step 304 of retrieving, by a data retrieval module 106 of the host server 100 and from a customer database 22 of the host server 100, details of payment vehicles linked to the mobile devices 200 based on the device identifier data;
c. a step 306 of searching a transaction database 24 of the host server 100, by a search module 108 of the host server 100, for past transactions associated with the payment vehicles based on the details thereof; and
d. a step 308 of selecting, by a selection module 110 of the host server 100, a set of payment vehicles based on the search results, each selected payment vehicle having performed at least one past transaction at the merchant location.

In a step 310 of the method 300, the electronic content such as electronic advertisements are subsequently receivable on the mobile devices 200 linked to the selected set of payment vehicles, and the electronic advertisements are selected based on the past transactions performed by the selected set of payment vehicles at the merchant location. The electronic advertisements can thus be more targeted to the customers based on the proximity to and past transactions at the merchant location. There would also be increased expectation that the customers may make purchases upon seeing the electronic advertisements, such as if the offers in the advertisements are attractive and/or relate to a customer's favourite merchant operating at the merchant location. This would eventually lead to increased sales for the merchants and also increased revenue for the issuer financial institutions 30 due to the increased spending.

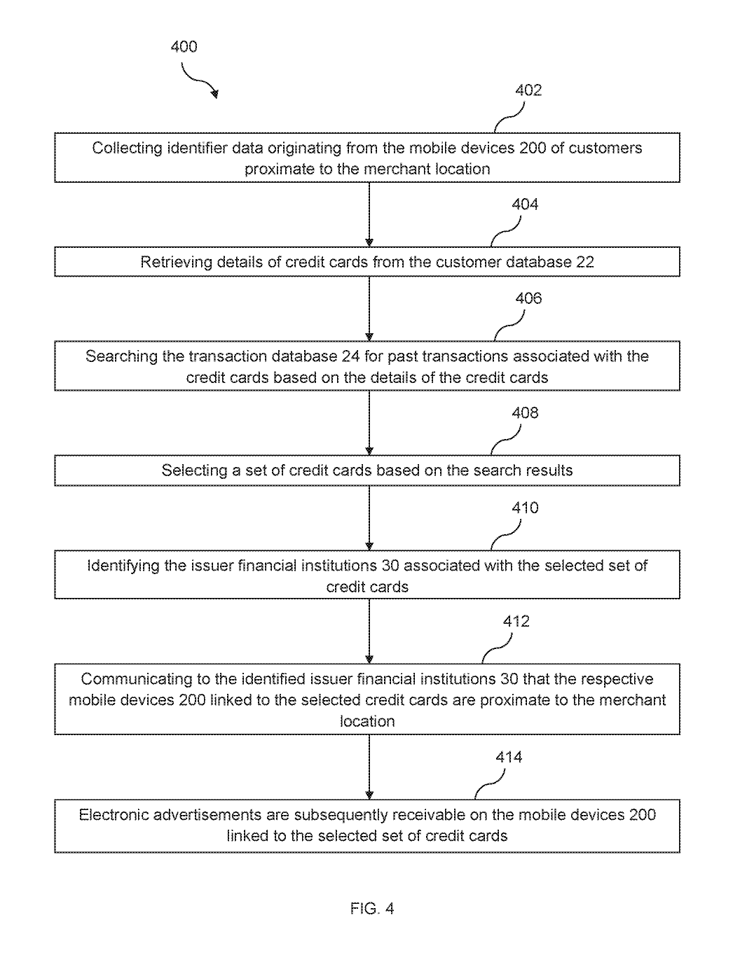

A representative or exemplary embodiment of the method 300 implemented on the host server 100 is described hereafter as a method 400 with reference to FIG. 4. In this embodiment, the payment vehicle may be a payment card such as a credit card. However, it would be appreciated various aspects of this embodiment may apply analogously to other forms of payment cards, payment vehicles or instruments that can be linked to the mobile devices 200 to create digital wallets for the customers.

The method 400 comprises a step 402 of collecting device identifier data of the mobile devices 200 of customers proximate to the merchant location, i.e. when the mobile devices 200 are close to, nearby, or at the merchant location. The step 402 is performed by the data collection module 104 of the host server 100 and the device identifier data of the mobile devices 200 is collected from the computing system 50 at the merchant location. Particularly, for each mobile device 200, the device identifier data is carried by a data signal or data packet that is continuously or continually broadcasted by the mobile device 200. The data signals broadcasted by the mobile devices 200 seeks out or searches for data signals broadcasted by the beacon device 60 of the computing system 50, similar to how the mobile devices 200 would search for Wi-Fi signals. When the beacon device 60 is within a broadcast range of a mobile device 200, i.e. the mobile device 200 is also within a broadcast range of the beacon device 60, the data signal from the mobile device 200 can communicate with the identifier data signal broadcasted from the beacon device 60, thereby enabling the mobile device 200 to automatically detect the beacon device 60. The proximity engagement of the mobile device 200 and the beacon device 60 when they are proximate to each other may occur through known technologies such as Wi-Fi Aware and Bluetooth Smart.

When the mobile device 200 and the beacon device 60 are within each other's broadcast range, both devices engage each other and become communicative with each other. The data signal that is broadcasted by the mobile device 200 is communicated, via the beacon device 60, to the computing system 50. The computing system 50 also receives the device identifier data that is carried by the broadcasted data signal. The device identifier data may comprise a media access control (MAC) address and is unique to the mobile device 200. Each mobile device 200 has its own MAC address that allows the beacon device 60, and other computing devices within the network, to uniquely identify the mobile device 200 among other devices.

The MAC addresses of the mobile devices 200 may be extracted from their broadcasted data signals at the computing system 50 for collection by the host server. The host server 100 thus collects all the MAC addresses of the mobile devices 200 when they are proximate to the merchant location. For example, when customers carrying the mobile devices 200 enter a merchant location, e.g. a shopping mall, the mobile devices 200 may be communicative with the beacon device 60, enabling the MAC addresses from the mobile devices 200 to be transmitted to the computing system 50 via the beacon device 60 and subsequently collected by the host server 100.

The method 400 further comprises a step 404 of retrieving details of credit cards from the customer database 22 of the host server 100. The step 404 is performed by the data retrieval module 106 of the host server 100. The details of the credit cards are retrieved based on the device identifier data or MAC addresses collected in the step 402. As each MAC address represents a mobile device 200, if the mobile device 200 is linked to a credit card, the mobile device 200 can operate as a digital wallet to pay for transactions. Details of the digital wallets, particularly the MAC addresses of the mobile devices 200 and the linked credit card details, are recorded on the customer database 22. Each MAC address may be linked to or associated with one or more credit cards, e.g. if a single mobile device 200 is linked with several credit cards. Similarly, a credit card may be linked to or associated with one or more MAC addresses, e.g. if a customer has multiple mobile devices 200.

The links or associations between credit card details and MAC addresses would only exist on the customer database 22 if there has been at least one past transaction made by the customer with his/her digital wallet. If the customer is a first-time user of a digital wallet, he/she would firstly need to configure the mobile device 200 by linking it to his/her preferred credit card using the software application executable on the mobile device 200. When the customer transacts with a merchant, he/she operates the digital wallet with the software application on the mobile device 200 and pays for the transaction via the merchant billing machine. The communication between the mobile device 200 and the merchant billing machine may occur via near-field communication (NFC) and may require additional authentication by the customer, as would be readily known to the skilled person. The merchant billing machine receives the credit card details from the digital wallet, together with the

MAC address of the mobile device 200. The MAC address and credit card details are communicated to the host server 100 for subsequent processing by the payment network 20. In addition, the host server 100 records the MAC address and credit card details, as well as the link/association therebetween, on the customer database 22. The first transaction using the digital wallet on the mobile device 200 thus establishes the link/association between the MAC address of the mobile device 200 and the credit card used for the digital wallet.

Once this link/association has been established as a result of the first transaction, subsequent transactions paid by the customer with the digital wallet will be recorded on the transaction database 24 and associated with the MAC address of the mobile device 200 used as the digital wallet. In the step 404, the host server 100 would be able to retrieve information on the digital wallets from the customer database 22, including details of the credit cards linked to the mobile devices 200, based on the MAC addresses of the mobile devices 200.

The method 400 further comprises a step 406 of searching the transaction database 24 of the host server 100 for past transactions associated with the credit cards based on the details of the credit cards retrieved in the step 404. The step 406 is performed by the search module 108 of the host server 100. The credit card details may comprise the Primary Account Number (PAN) of the credit card which, for most credit cards, is a 16-digit number. The credit card details may further comprise the customer's name on the credit card and the expiry date of the credit card. There would be at least one past transaction associated with the credit card as the credit card details are retrievable based on the MAC address, meaning that a customer has used his/her digital wallet on the mobile device 200 at least once. The step 406 searches for all past transactions that the customer has made with the digital wallet. The search results may provide information on the past transactions, such as merchant names and locations, transaction values/costs, dates and times of transactions, products/services purchased, etc.

The method 400 further comprises a step 408 of selecting a set of credit cards based on the search results. The step 408 is performed by the selection module 110 of the host server 100. The selection of the set of credit cards is based on the search results, particularly on the merchant location of the past transactions. For each credit card determined in the step 404, the step 408 assesses whether the credit card has performed at least one past transaction at the merchant location based on the search results which would have determined information on the merchant locations of the past transactions. If the assessment is positive, it means that the customer has used his/her digital wallet (configured with the assessed credit card) on the mobile device 200 to pay for at least one past transaction at this merchant location, and this credit card would be selected in the step 408. Conversely, if the assessment is negative, it means that the customer has never used his/her digital wallet at this merchant location, and this credit card would not be selected in the step 408. The step 408 proceeds to assess the remaining credit cards until all available credit cards (obtained from the step 404) have been assessed and selected where appropriate.

After the step 408 of selecting all the credit cards that have performed at least one past transaction at the merchant location, the method 400 proceeds to a step 410 of identifying the issuer financial institutions 30 associated with the selected set of credit cards. The step 410 is performed for each of the selected credit cards by the identification module 112 of the host server 100, and is based on the details of the selected credit cards retrieved in the step 404. For a selected credit card, the associated issuer financial institution 30 may be identified from the 16-digit credit card number in the credit card details. The number group of consisting of the first 6 digits of the credit card number represents the issuer identification number or bank identification number. This number group uniquely identifies the issuer financial institution 30 which issued the selected credit card to the customer.

The method 400 further comprises a step 412 of communicating to the identified issuer financial institutions 30 that the respective mobile devices 200 linked to the selected credit cards are proximate to the merchant location. The step 412 is performed by the communication module 114 of the host server 100, and the communication between the host server 100 and the issuer financial institutions 30 may be through the payment network 20. The communication to the issuer financial institutions 30 may include details of the selected credit cards and/or associated

MAC addresses of the mobile devices 200. The communication to the issuer financial institutions 30 may additional include information on whether the customer wishes to receive the electronic advertisements, as some customers may have configured on their user profile to decline sharing of their transactions information for advertisement purposes.

In a step 414 of the method 400, the electronic advertisements are subsequently receivable on the mobile devices 200 linked to the selected set of credit cards. Specifically, with the issuer financial institutions 30 identified in the step 410, for each selected credit card, the electronic advertisements can be subsequently communicated from the identified issuer financial institution 30 to the mobile device 200 linked to the selected credit card. The issuer financial institution 30 can retrieve the contact details of the customer from the financial database 40 based on the credit card details. The contact details may include the phone number associated with the mobile device 200, allowing the issuer financial institution 30 to transmit the electronic advertisements via SMS.

In addition, the electronic advertisements are selected based on the past transactions performed by the selected set of credit cards at the merchant location. Specifically, for each mobile device 200 receiving the electronic advertisements, the electronic advertisements may be selected from an advertisement database of the respective issuer financial institution 30. The advertisement database may contain multiple advertisements or advertising materials that may be provided by the issuer financial institution, e.g. for offering credit card discounts or rebates, and/or by the merchants, e.g. for offering product promotions or discounts.

The selection of electronic advertisements is based on the search results of the past transactions in the step 406. The past transactions may provide information such as the types of products that the customer has previously purchased at this merchant location, e.g. a shopping mall. For example, a customer may have previously purchased with his/her digital wallet some products at one or more merchants operating at the shopping mall. The selected electronic advertisements may be related to the one or more merchants where the customer has previously purchased from. As the electronic advertisements are communicated to the mobile device 200 of the customer when the mobile device 200 is proximate to the merchant location, i.e. when the customer has entered the shopping mall, the electronic advertisements remind the customer that he/she has previously purchased some products from the one or more merchants. If the customer finds the offers in the electronic advertisements attractive, he/she can easily visit the one or more merchants as he/she is nearby and possibly make new purchases with them. Alternatively, instead of being related to the one or more merchants, the electronic advertisements may be related to the products which the customer has previously purchased. For example, the electronic advertisements may offer promotions on similar products sold by a competing merchant in the same shopping mall.

Therefore, the electronic advertisements communicated to the mobile devices 200 are more relevant to the customers, possibly resulting in a higher yield or hit rate per advertisement, i.e. the customers are more likely to positively respond to the advertisements. The selected electronic advertisements are based on proximity to the merchant location and information from past transactions, and communicated to the customers in real-time, e.g. when the customers have entered the shopping mall. This advantageously provides the customers with the relevant offers at the right time and location, and provides the merchants with the right prospects. There would thus be a greater probability of the customers making purchases upon seeing such targeted advertisements and especially so if the customers are already near to or at the merchant location. This would eventually lead to increased sales for the merchants and also increased revenue for the issuer financial institutions 30 due to the increased spending on the payment cards/credit cards issued by them.

In the foregoing detailed description, embodiments of the present disclosure in relation to a method and system for selectively providing electronic content to mobile devices are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A computerized method implemented on a system for selectively providing electronic content to mobile devices, the method comprising:
collecting, by a host server and from a computing system at a merchant location, device identifier data of the mobile devices proximate to the merchant location;
retrieving, from a customer database of the host server, details of payment vehicles linked to the mobile devices based on the device identifier data;
searching a transaction database of the host server for past transactions associated with the payment vehicles based on the details thereof;
selecting a set of payment vehicles based on the search results, each selected payment vehicle having performed at least one past transaction at the merchant location;
identifying, for each selected payment vehicle, an issuer financial institution associated with the selected payment vehicle based on the details thereof;
communicating details of the selected set of payment vehicles from the host server to the respective issuer financial institutions; and
communicating the electronic content from the identified issuer financial institutions to the respective mobile devices linked to the selected payment vehicles,
wherein the electronic content is selected based on the past transactions performed by the selected set of payment vehicles at the merchant location.

2. A computerized method implemented on a host server for selectively providing electronic content to mobile devices, the method comprising:
collecting, by a data collection module of the host server and from a computing system at a merchant location, device identifier data of the mobile devices proximate to the merchant location;
retrieving, by a data retrieval module of the host server and from a customer database of the host server, details of payment vehicles linked to the mobile devices based on the device identifier data;
searching a transaction database of the host server, by a search module of the host server, for past transactions associated with the payment vehicles based on the details thereof; and
selecting, by a selection module of the host server, a set of payment vehicles based on the search results, each selected payment vehicle having performed at least one past transaction at the merchant location,
wherein the electronic content is subsequently receivable on the mobile devices linked to the selected set of payment vehicles; and
wherein the electronic content is selected based on the past transactions performed by the selected set of payment vehicles at the merchant location.

3. The method according to claim 2, further comprising identifying, for each selected payment vehicle and by an identification module of the host server, an issuer financial institution associated with the selected payment vehicle based on the details thereof.

4. The method according to claim 3, further comprising communicating, by a communication module of the host server, to the identified issuer financial institutions that the respective mobile devices linked to the selected payment vehicles are proximate to the merchant location.

5. The method according to claim 4, wherein the electronic content is subsequently communicated from the identified issuer financial institutions to the respective mobile devices linked to the selected payment vehicle.

6. The method according to claim 2, wherein for each mobile device, the device identifier data is carried by a data signal broadcasted therefrom.

7. The method according to claim 6, wherein the broadcasted data signal automatically detects a beacon device of the computing system when the beacon device is within a broadcast range of the mobile device.

8. The method according to claim 7, wherein the broadcasted data signal is communicated from the mobile device to the computing system upon detection of the beacon device.

9. The method according to claim 6, wherein the device identifier data of the mobile devices is extracted from the broadcasted data signals at the computing system for collection by the host server.

10. A host server for selectively providing electronic content to mobile devices, the host server comprising:
a processor for executing computer-readable instructions and a data storage device comprising:
a data collection module comprising instructions for collecting, from a computing system at a merchant location, device identifier data of the mobile devices proximate to the merchant location;
a data retrieval module comprising instructions for retrieving, from a customer database of the host server, details of payment vehicles linked to the mobile devices based on the device identifier data;
a search module comprising instructions for searching a transaction database of the host server for past transactions associated with the payment vehicles based on the details thereof; and
a selection module comprising instructions for selecting a set of payment vehicles based on the search results, each selected payment vehicle having performed at least one past transaction at the merchant location,
wherein the electronic content is subsequently receivable on the mobile devices linked to the selected set of payment vehicles; and
wherein the electronic content is selected based on the past transactions performed by the selected set of payment vehicles at the merchant location.

11. The host server according to claim 10, further comprising an identification module for identifying, for each selected payment vehicle, an issuer financial institution associated with the selected payment vehicle based on the details thereof.

12. The host server according to claim 11, further comprising a communication module for communicating to the identified issuer financial institutions that the respective mobile devices linked to the selected payment vehicles are proximate to the merchant location.

13. The host server according to claim 12, wherein the electronic content is subsequently communicated from the identified issuer financial institutions to the respective mobile devices linked to the selected payment vehicle.

14. The host server according to claim 10, wherein for each mobile device, the device identifier data is carried by a data signal broadcasted therefrom.

15. The host server according to claim 14, wherein the broadcasted data signal automatically detects a beacon device of the computing system when the beacon device is within a broadcast range of the mobile device.

16. The host server according to claim 15, wherein the broadcasted data signal is communicated from the mobile device to the computing system upon detection of the beacon device.

17. The host server according to claim 14, wherein the device identifier data of the mobile devices is extracted from the broadcasted data signals at the computing system for collection by the host server.

18. A non-transitory computer-readable medium storing computer-readable instructions that, when executed, cause a processor of a host server to perform steps of a method for selectively providing electronic content to mobile devices, the steps comprising:
collecting, by a data collection module of the host server and from a computing system at a merchant location, device identifier data of the mobile devices proximate to the merchant location;
retrieving, by a data retrieval module of the host server and from a customer database of the host server, details of payment vehicles linked to the mobile devices based on the device identifier data;
searching a transaction database of the host server, by a search module of the host server, for past transactions associated with the payment vehicles based on the details thereof; and
selecting, by a selection module of the host server, a set of payment vehicles based on the search results, each selected payment vehicle having performed at least one past transaction at the merchant location,
wherein the electronic content is subsequently receivable on the mobile devices linked to the selected set of payment vehicles; and
wherein the electronic content is selected based on the past transactions performed by the selected set of payment vehicles at the merchant location.

19. The non-transitory computer-readable medium according to claim 18, the steps further comprising identifying, for each selected payment vehicle and by an identification module of the host server, an issuer financial institution associated with the selected payment vehicle based on the details thereof.

20. The non-transitory computer-readable medium according to claim 19, the steps further comprising communicating, by a communication module of the host server, to the identified issuer financial institutions that the respective mobile devices linked to the selected payment vehicles are proximate to the merchant location.

21. The non-transitory computer-readable medium according to claim 20, wherein the electronic content is subsequently communicated from the identified issuer financial institutions to the respective mobile devices linked to the selected payment vehicle.

22. The non-transitory computer-readable medium according to claim 18, wherein for each mobile device, the device identifier data is carried by a data signal broadcasted therefrom.

23. The non-transitory computer-readable medium according to claim 22, wherein the broadcasted data signal automatically detects a beacon device of the computing system when the beacon device is within a broadcast range of the mobile device.

24. The non-transitory computer-readable medium according to claim 23, wherein the broadcasted data signal is communicated from the mobile device to the computing system upon detection of the beacon device.

25. The non-transitory computer-readable medium according to claims 22, wherein the device identifier data of the mobile devices is extracted from the broadcasted data signals at the computing system for collection by the host server.
